(19) United States
(12) Patent Application Publication
(10) Pub. No.: US 2024/0364563 A1
(43) Pub. Date: Oct. 31, 2024

(54) TECHNIQUES FOR CONTROL SIGNAL CONFIGURATION FOR REFERENCE SIGNAL PRECODING

(71) Applicant: QUALCOMM Incorporated, San Diego, CA (US)

(72) Inventors: Ahmed ELSHAFIE, San Diego, CA (US); Muhammad Sayed Khairy ABDELGHAFFAR, San Jose, CA (US); Alexandros MANOLAKOS, Athens (GR); Yi HUANG, San Diego, CA (US)

(21) Appl. No.: 18/291,136

(22) PCT Filed: Aug. 22, 2022
(86) PCT No.: PCT/US2022/041060

§ 371 Date: Jan. 22, 2024

(30) Foreign Application Priority Data
Sep. 15, 2021 (GR) 20210100607

(51) Int. Cl. H04L 25/02

(52) U.S. Cl. CPC H04L 25/021; H04L 25/0224

(57) ABSTRACT

Methods, systems, and devices for wireless communications are described. A user equipment (UE) may precode sounding reference signals using an interference covariance matrix to report channel quality information to a base station. For example, a UE may receive an indication of a future time from a base station. The future time may correspond to a future time for which the UE may predict an interference covariance matrix. In some cases, based on receiving the indication, the UE may monitor for interference in one or more interference measurement resources. In some examples, the UE may then determine the predicted interference covariance matrix and may transmit a sounding reference signal to the base station. The sounding reference signal may be precoded based on the predicted interference covariance matrix. In some cases, the UE may receive a downlink signal from the base station at the future time or at a second time.

### CROSS REFERENCE

The present Application is a 371 national stage filing of International PCT Application No. PCT/US2022/041060 by ELSHAFIE et al. entitled “TECHNIQUES FOR CONTROL SIGNAL CONFIGURATION FOR REFERENCE SIGNAL PRECODING,” filed Aug. 22, 2022; and claims priority to Greece Patent Application No. 20210100607 by ELSHAFIE et al., entitled “TECHNIQUES FOR CONTROL SIGNAL CONFIGURATION FOR REFERENCE SIGNAL PRECODING,” filed Sep. 15, 2021, each of which is assigned to the assignee hereof, and each of which is expressly incorporated by reference in its entirety herein.

### FIELD OF TECHNOLOGY

The following relates to wireless communications, including techniques for control signal configuration for reference signal precoding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). A UE may be configured to support beamformed communications via directional beams. For example, the UE may be configured with multiple antenna panels to support the beamformed communications. However, in some cases, existing beamforming techniques may be deficient.

### SUMMARY

The described techniques relate to improved methods, systems, devices, and apparatuses that support techniques for control signal configuration for reference signal precoding. Generally, a user equipment (UE) may receive an indication of a future time from a base station. In some cases, the future time may correspond to a future time for which the UE is expected to determine a predicted interference covariance matrix. In some cases, based on receiving the indication, the UE may monitor for interference in one or more interference measurement resources. In some examples, the UE may then determine the predicted interference covariance matrix. In some cases, the UE may transmit a sounding reference signal (SRS) to the base station. In some examples, the SRS may be precoded based on the predicted interference covariance matrix. In some cases, the UE may then receive a downlink signal from the base station at the future time or at a second time.

A method for wireless communications at a UE is described. The method may include receiving, from a base station, an indication of a future time for which the UE is expected to determine a predicted interference covariance matrix, monitoring for interference in one or more interference measurement resources based on receiving the indication, determining the predicted interference covariance matrix based on the monitoring for the interference, and transmitting an SRS to the base station, the SRS precoded based on the predicted interference covariance matrix.

An apparatus for wireless communications is described. The apparatus may include a processor, memory coupled with the processor, and instructions stored in the memory. The instructions may be executable by the processor to cause the apparatus to receive, from a base station, an indication of a future time for which the UE is expected to determine a predicted interference covariance matrix, monitor for interference in one or more interference measurement resources based on receiving the indication, determine the predicted interference covariance matrix based on the monitoring for the interference, and transmit an SRS to the base station, the SRS precoded based on the predicted interference covariance matrix.

Another apparatus for wireless communications is described. The apparatus may include means for receiving, from a base station, an indication of a future time for which the UE is expected to determine a predicted interference covariance matrix, means for monitoring for interference in one or more interference measurement resources based on receiving the indication, means for determining the predicted interference covariance matrix based on the monitoring for the interference, and means for transmitting an SRS to the base station, the SRS precoded based on the predicted interference covariance matrix.

A non-transitory computer-readable medium storing code for wireless communications at a UE is described. The code may include instructions executable by a processor to receive, from a base station, an indication of a future time for which the UE is expected to determine a predicted interference covariance matrix, monitor for interference in one or more interference measurement resources based on receiving the indication, determine the predicted interference covariance matrix based on the monitoring for the interference, and transmit an SRS to the base station, the SRS precoded based on the predicted interference covariance matrix.

In some examples of the method, apparatuses, and non-transitory computer-readable medium described herein, receiving the indication may include operations, features, means, or instructions for receiving the indication as part of an SRS configuration for transmission of the SRS.

In some examples of the method, apparatuses, and non-transitory computer-readable medium described herein, receiving the indication may include operations, features, means, or instructions for receiving first control signaling identifying a set of lists, each list of the set of lists including a respective quantity of future times and receiving second control signaling identifying a selected list of the set of lists, the selected list including the indicated future time.

Some examples of the method, apparatuses, and non-transitory computer-readable medium described herein may further include operations, features, means, or instructions for identifying, in the first control signaling, a first resource list including the one or more interference management resources and a second resource list including a set of resources for transmission of the SRS, the set of resources based on an antenna configuration at the UE, where monitoring for the interference and transmitting the SRS may be based on identifying the first resource list and the second resource list.

In some examples of the method, apparatuses, and non-transitory computer-readable medium described herein, receiving the indication may include operations, features, means, or instructions for receiving first control signaling identifying an integer quantity, monitoring, based on receiving the first control signaling, for second control signaling identifying a set of multiple future times whose quantity may be the integer quantity, and receiving the second control signaling based on the monitoring, the set of multiple future times including the indicated future time.

Some examples of the method, apparatuses, and non-transitory computer-readable medium described herein may further include operations, features, means, or instructions for receiving control signaling identifying the one or more interference measurement resources and a resource for transmission of the SRS, where monitoring for the interference and transmitting the SRS may be based on receiving the control signaling.

In some examples of the method, apparatuses, and non-transitory computer-readable medium described herein, receiving the control signaling may include operations, features, means, or instructions for receiving a first identification of a respective time associated with each of the one or more interference measurement resources, each respective time relative to the control signaling and receiving a second identification of a time associated with the resource for the transmission of the SRS, the time relative to the control signaling.

In some examples of the method, apparatuses, and non-transitory computer-readable medium described herein, determining the predicted interference covariance matrix may include operations, features, means, or instructions for receiving one or more signals based on monitoring for the interference, estimating a first interference covariance matrix for a time associated with the one or more interference measurement resources based on receiving the one or more signals, and determining the predicted interference covariance matrix based on a mean of the one or more signals, an autocorrelation, an auto-covariation, a cross-correlation, a cross-covariance, a stationary interference process, or any combination thereof.

Some examples of the method, apparatuses, and non-transitory computer-readable medium described herein may further include operations, features, means, or instructions for receiving, at the future time or at a second time, a downlink signal from the base station based on transmitting the SRS and on the predicted interference covariance matrix.

In some examples of the method, apparatuses, and non-transitory computer-readable medium described herein, the indication may be received in a radio resource control (RRC) message, a medium access control control element (MAC-CE), a downlink control information (DCI) message, or any combination thereof.

In some examples of the method, apparatuses, and non-transitory computer-readable medium described herein, the future time includes one or more slots, one or more subslots, one or more symbols, or any combination thereof.

A method for wireless communications at a base station is described. The method may include transmitting, to a UE, an indication of a future time for which the UE is expected to determine a predicted interference covariance matrix, receiving an SRS from the UE based on transmitting the indication, the SRS precoded based on the predicted interference covariance matrix, determining the predicted interference covariance matrix based on the SRS, and transmitting a downlink signal using one or more transmission parameters that are based on the predicted interference covariance matrix.

An apparatus for wireless communications is described. The apparatus may include a processor, memory coupled with the processor, and instructions stored in the memory. The instructions may be executable by the processor to cause the apparatus to transmit, to a UE, an indication of a future time for which the UE is expected to determine a predicted interference covariance matrix, receive an SRS from the UE based on transmitting the indication, the SRS precoded based on the predicted interference covariance matrix, determine the predicted interference covariance matrix based on the SRS, and transmit a downlink signal using one or more transmission parameters that are based on the predicted interference covariance matrix.

Another apparatus for wireless communications is described. The apparatus may include means for transmitting, to a UE, an indication of a future time for which the UE is expected to determine a predicted interference covariance matrix, means for receiving an SRS from the UE based on transmitting the indication, the SRS precoded based on the predicted interference covariance matrix, means for determining the predicted interference covariance matrix based on the SRS, and means for transmitting a downlink signal using one or more transmission parameters that are based on the predicted interference covariance matrix.

A non-transitory computer-readable medium storing code for wireless communications at a base station is described. The code may include instructions executable by a processor to transmit, to a UE, an indication of a future time for which the UE is expected to determine a predicted interference covariance matrix, receive an SRS from the UE based on transmitting the indication, the SRS precoded based on the predicted interference covariance matrix, determine the predicted interference covariance matrix based on the SRS, and transmit a downlink signal using one or more transmission parameters that are based on the predicted interference covariance matrix.

In some examples of the method, apparatuses, and non-transitory computer-readable medium described herein, transmitting the indication may include operations, features, means, or instructions for transmitting the indication as part of an SRS configuration for transmission, by the UE, of the SRS.

In some examples of the method, apparatuses, and non-transitory computer-readable medium described herein, transmitting the indication may include operations, features, means, or instructions for transmitting first control signaling identifying a set of lists, each list of the set of lists including a respective quantity of future times and transmitting second control signaling identifying a selected list of the set of lists, the selected list including the indicated future time.

In some examples of the method, apparatuses, and non-transitory computer-readable medium described herein, the first control signaling includes a first resource list including the one or more interference management resources and a second resource list including a set of resources for transmission of the SRS, the set of resources based on an antenna configuration at the UE, and the SRS may be received based on the first resource list and the second resource list.

In some examples of the method, apparatuses, and non-transitory computer-readable medium described herein, transmitting the indication may include operations, features, means, or instructions for transmitting first control signaling identifying an integer quantity and transmitting second control signaling identifying a set of multiple future times whose quantity may be the integer quantity, the set of multiple future times including the indicated future time.

Some examples of the method, apparatuses, and non-transitory computer-readable medium described herein may further include operations, features, means, or instructions for transmitting control signaling identifying one or more interference measurement resources and a resource for transmission of the SRS.

In some examples of the method, apparatuses, and non-transitory computer-readable medium described herein, transmitting the control signaling may include operations, features, means, or instructions for transmitting a first identification of a respective time associated with each of the one or more interference measurement resources, each respective time relative to the control signaling and transmitting a second identification of a time associated with the resource for the transmission of the SRS, the time relative to the control signaling.

Some examples of the method, apparatuses, and non-transitory computer-readable medium described herein may further include operations, features, means, or instructions for determining the one or more transmission parameters for the downlink signal scheduled for transmission at the future time, where the one or more transmission parameters may be determined based on the predicted interference covariance matrix.

Some examples of the method, apparatuses, and non-transitory computer-readable medium described herein may further include operations, features, means, or instructions for transmitting the downlink signal to the UE at the future time based on determining the one or more transmission parameters.

In some examples of the method, apparatuses, and non-transitory computer-readable medium described herein, the one or more transmission parameters include a precoder, a modulation and coding scheme, a rank indicator, or any combination thereof, associated with the downlink signal.

Some examples of the method, apparatuses, and non-transitory computer-readable medium described herein may further include operations, features, means, or instructions for determining the one or more transmission parameters for the downlink signal scheduled for transmission at a second time, where the one or more transmission parameters may be determined based on the predicted interference covariance matrix and an interpolation and transmitting the downlink signal to the UE at the second time based on determining the one or more transmission parameters.

In some examples of the method, apparatuses, and non-transitory computer-readable medium described herein, the indication may be transmitted in an RRC message, a MAC-CE, a DCI message, or any combination thereof.

In some examples of the method, apparatuses, and non-transitory computer-readable medium described herein, the future time includes one or more slots, one or more subslots, one or more symbols, or any combination thereof.

### BRIEF DESCRIPTION OF THE DRAWINGS

FIGS. 1 and 2 illustrate examples of wireless communications systems that supports techniques for control signal configuration for reference signal precoding in accordance with aspects of the present disclosure.

FIG. 3 illustrates an example of a timing diagram that supports techniques for control signal configuration for reference signal precoding in accordance with aspects of the present disclosure.

FIG. 4 illustrates an example of a process flow in a system that supports techniques for control signal configuration for reference signal precoding in accordance with aspects of the present disclosure.

FIGS. 5 and 6 show block diagrams of devices that support techniques for control signal configuration for reference signal precoding in accordance with aspects of the present disclosure.

FIG. 7 shows a block diagram of a communications manager that supports techniques for control signal configuration for reference signal precoding in accordance with aspects of the present disclosure.

FIG. 8 shows a diagram of a system including a device that supports techniques for control signal configuration for reference signal precoding in accordance with aspects of the present disclosure.

FIGS. 9 and 10 show block diagrams of devices that support techniques for control signal configuration for reference signal precoding in accordance with aspects of the present disclosure.

FIG. 11 shows a block diagram of a communications manager that supports techniques for control signal configuration for reference signal precoding in accordance with aspects of the present disclosure.

FIG. 12 shows a diagram of a system including a device that supports techniques for control signal configuration for reference signal precoding in accordance with aspects of the present disclosure.

FIGS. 13 through 16 show flowcharts illustrating methods that support techniques for control signal configuration for reference signal precoding in accordance with aspects of the present disclosure.

### DETAILED DESCRIPTION

Some wireless communications systems may support ultra-reliable low-latency communications (URLLC) applications. Accordingly, to maintain a service reliability which supports URLLC applications, a base station may indicate (e.g., via control signaling) a channel state information (CSI) reporting configuration to a user equipment (UE). The UE may, in response, measure and report CSI parameters (e.g., a channel quality information (CQI), a precoding matrix indicator (PMI), a CSI reference signal (CSI-RS) indicator (CRI), or a rank indicator (RI)) in accordance with the configuration. However, in some cases, CSI reporting may increase latency beyond what may be acceptable for URLLC applications.

According to the techniques described herein, a UE may precode reference signals (e.g., sounding reference signals (SRSs)) using an interference covariance matrix (Rnn) to report channel quality information to a base station. In some cases, a UE may use interference measurements and modeling to predict interference at future times (e.g., future times in which the base station may transmit signals to the UE). For example, a UE may use CSI interference measurement (CSI-IM) resources (e.g., time and frequency resources) to measure interference and predict Rnn at future times. In some cases, the UE may then precode one or more SRSs with a predicted Rnn. A base station may then use the precoded SRSs to determine CSI parameters (e.g., a PMI, a modulation and coding scheme (MCS), or an RI) for transmitting signals to the UE at the times corresponding to the predicted Rnns. In some instances, precoding SRSs with predicted interference covariance matrices may reduce signaling overhead and improve CSI parameter determinations made by the base station. In some examples, a base station may indicate timing information for Rnn predictions to the UE via control signaling. In some cases, the timing information may include one or more list of future times that the UE may use for Rnn predictions (e.g., Rnn prediction times). In some other cases, the timing information may include a parameter (R) which may be associated with a quantity of Rnn prediction times. Additionally or alternatively, a base station may indicate (e.g., via control signaling) one or more CSI-IM resources to be measured by the UE for Rnn predictions as well as one or more SRS resources to be precoded with the Rnn predictions. In some cases, a base station may transmit control signaling which indicates a list of CSI-IM resource, a list of SRS resources, and one or more lists of Rnn prediction times.

One or more aspects of the disclosure are initially described in the context of wireless communications systems. An example timing diagram and an example process flow illustrating one or more aspects of the discussed techniques are then described. Aspects of the disclosure are further illustrated by and described with reference to apparatus diagrams, system diagrams, and flowcharts that relate to techniques for control signal configuration for reference signal precoding.

Aspects of the subject matter described herein may be implemented to realize one or more advantages. The described techniques may support improvements in wireless communications systems by reducing signaling overhead. Further, in some examples, techniques for control signal configuration for reference signal precoding, as described herein, may support higher data rates, thereby improving latency and reliability. As such, supported techniques may include improved network operations, and, in some examples, may promote network efficiencies, among other benefits.

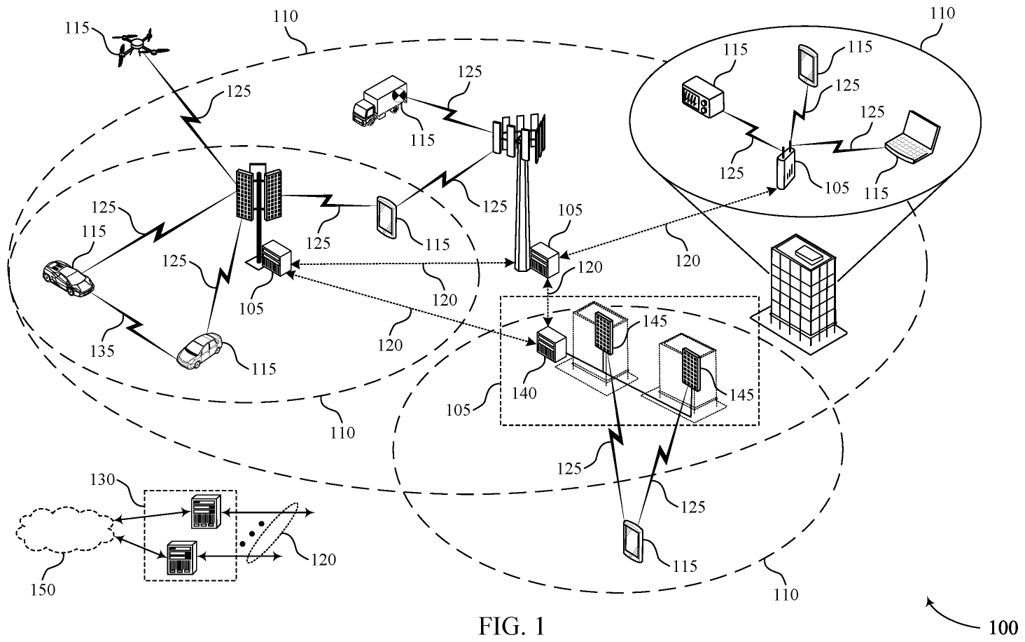

FIG. 1 illustrates an example of a wireless communications system 100 that supports techniques for control signal configuration for reference signal precoding in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support URLLC. The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a ULE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the wireless communications system 100 may support one or more aspects of the techniques for control signal configuration for reference signal precoding indicated by a base station 105 to a UE 115. For example, a UE 115 may receive an indication of a future time from a base station 105. In some cases, the future time may correspond to a future time for which the UE 115 is expected to determine a predicted interference covariance matrix. In some cases, based on receiving the indication, the UE 115 may monitor for interference in one or more interference measurement resources. In some examples, the UE 115 may then determine the predicted interference covariance matrix. In some cases, the UE 115 may transmit an SRS to the base station 105. In some examples, the SRS may be precoded based on the predicted interference covariance matrix. In some cases, the UE 115 may then receive a downlink signal from the base station 105 at the future time or at a second time.

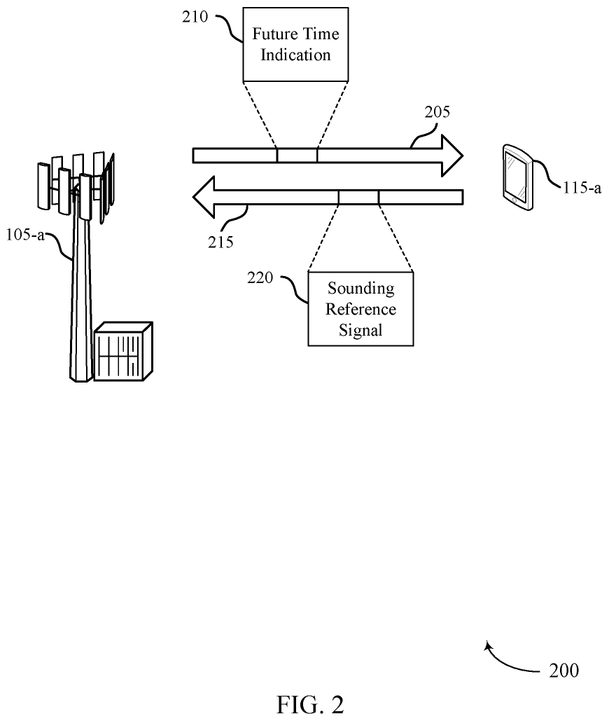

FIG. 2 illustrates an example of a wireless communications system 200 that supports techniques for control signal configuration for reference signal precoding in accordance with aspects of the present disclosure. In some examples, the wireless communications system 200 may implement aspects of wireless communications system 100. For instance, the wireless communications system 200 may include a base station 105-a as well as a UE 115-a which may be examples of the corresponding devices described with reference to FIG. 1.

As depicted in the example of FIG. 2, the base station 105-a may transmit one or more signals to the UE 115-a via a communication link 205 (e.g., a downlink communication link), and the UE 115-a may transmit one or more uplink signals to the base station 105-a via a communication link 215 (e.g., an uplink communication link). The wireless communications system 200 may include features for improved communications between the UE 115-a and the base station 105-a, among other benefits.

The wireless communications system 200 may support URLLC applications. In such examples, low latency and high service reliability may be desirable. For instance, the residual block error rate (BLER) for data transmissions to the UE 115-a may be low (e.g., on the order of 10−⁵) and delivered within a number (e.g., two) of HARQ transmissions. In some instances, interference may impact service reliability (i.e., the quality of service) for ultra-reliable communications, such as mission critical communications, low latency communications, or communications with low-cost and low-complexity devices. In some examples, CSI reporting may be used to improve service reliability in wireless communication systems (e.g., URLLC). However, in some instances, signaling overhead and resource usage associated with CSI reporting may be high and, as such, may increase latency beyond what may be acceptable for URLLC applications.

Aspects of the present disclosure provide techniques for reference signal precoding using an Rnn prediction. For instance, the UE 115-a may perform interference measurements to maintain or improve the reliability of communications with the base station 105-a. In some cases, the UE 115-a may use interference measurements to determine (e.g., estimate) Rnn, which may be a linear transform (e.g., an n×n matrix) used for randomizing (e.g., whitening) channel noise. The UE 115-a may then, in some cases, use models to predict Rnn at future times indicated by the base station 105-a, such as in a future time indication 210. In some examples, the UE 115-a may model interference as a stationary (e.g., random) process and may predict Rnn at future times using statistical parameters such as, a mean of one or more signals, an autocorrelation, an autocovariance, a cross-correlation, or a cross-covariance. In some cases, the UE 115-a may predict Rnn at future times based on an Rnn determined from interference measurements. Stated alternatively, the UE 115-a may use observed interference to predict Rnn at future times.

In some examples, the UE 115-a may communicate Rnn predictions to the base station 105-a by precoding one or more SRSs 220 with an Rnn prediction and then transmitting the one or more SRSs 220 to the base station 105-a. In some cases, precoded SRSs (e.g., the SRSs 220) may enable the base station 105-a to determine interference at the UE 115-a. For example, the base station 105-a may use precoded SRSs to determine CSI parameters (e.g., a PMI, an MCS, or an RI) for transmitting one or more signals to the UE. In some examples, CSI parameters determined from an Rnn prediction may be used for transmissions which occur at the time in which the Rnn prediction was based. Stated alternatively, the future time in which an Rnn prediction is based may correspond to a future time in which the base station 105-a may transmit one or more signals (e.g., downlink signals) to the UE 115-a. In some cases, the future time may correspond to a next downlink transmission (e.g., a downlink transmission following the reception of a precoded SRS). In some other cases, the future time may correspond to a transmission which may occur at a predetermined future time (e.g., subsequent to the next downlink transmission). In such cases, the base station 105-a may indicate timing information, to the UE 115-a, which the UE 115-a may use for Rnn predictions.

For example, the base station 105-a may transmit control signaling (e.g., RRC or downlink control information (DCI)) to indicate timing information that the UE 115-a may use for Rnn predictions. For instance, the base station 105-a may transmit a future time indication 210 to the UE 115-a via the communication link 205. In some cases, the future time indication 210 may indicate one or more future times that the UE 115-a may use for Rnn predictions (e.g., one or more Rnn prediction times). In some cases, the UE 115-a may predict Rnn (e.g., for the whitening channel) for each Rnn prediction time included in the future time indication 210. In some cases, the future time indication 210 may be included in an SRS resource configuration. In some cases, each Rnn prediction time may be represented as a slot, a subslot, a symbol, a time unit, or a combination thereof. In some examples, to predict an Rnn for an indicated Rnn prediction time, the UE 115-a may determine (e.g., compute) a time difference between the time the CSI-IM interference measurements may be performed and the time the precoded SRSs may be transmitted, as well as a time difference between the time the precoded SRSs are transmitted and the time in which the Rnn prediction is based (e.g., the Rnn prediction time).

For example, the base station 105-a transmit (e.g., via the communication link 205), to the UE 115-a, the future time indication 210 to the UE 115-a. In some examples the UE 115-a may be expected to determine a predicted Rnn based on the future time indication 210. In response to receiving the future time indication 210, the UE 115-a may monitor for interference in one or more interference measurement resources (e.g., CSI-IM resources) and, in some cases, determine a predicted Rnn. In some examples, the UE 115-a may then transmit (e.g., via the communication link 215) the SRS 220 to the base station 105-a. In some examples, the transmitted SRS 220 may be precoded based on the predicted Rnn.

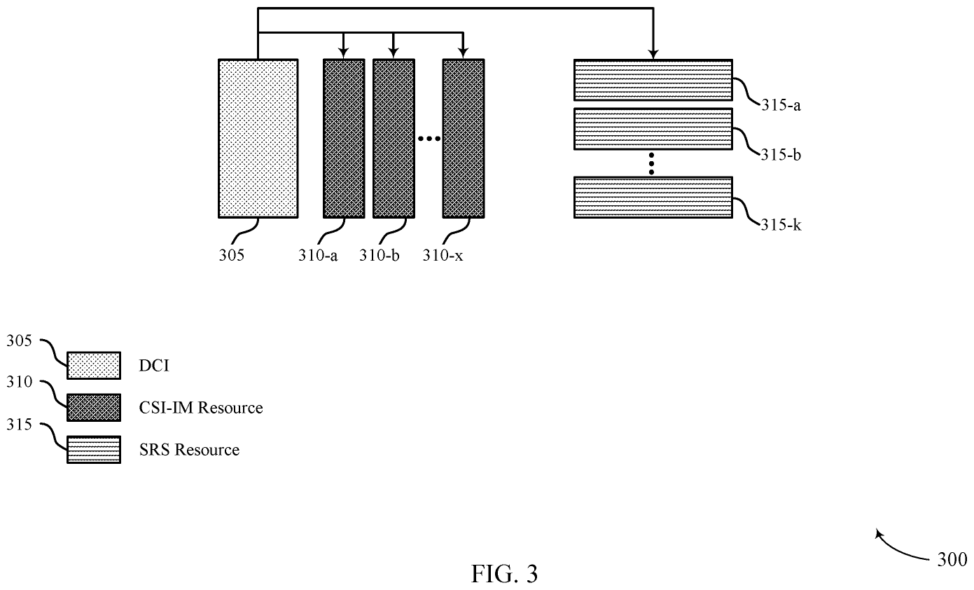

FIG. 3 illustrates an example of a timing diagram 300 that supports techniques for control signal configuration for reference signal precoding in accordance with aspects of the present disclosure. In some examples, the timing diagram 300 may be implemented by or may implement aspects of wireless communications systems 100 and 200. For instance, the timing diagram 300 may illustrate operations performed at one or more UEs 115 or one or more base stations 105 which may be examples of the corresponding devices described with reference to FIGS. 1 and 2.

In some examples, a base station may transmit a future time indication to a UE via control signaling (e.g., via a DCI 305, an RRC message, or a combination thereof). For example, a future time indication may be included in an SRS resource configuration. In some cases, the future time indication may indicate one or more future times in which the UE 115 may base Rnn predictions (e.g., one or more Rnn prediction times). In some cases, a base station may transmit an SRS resource configuration to a UE via an RRC message or a MAC control element (MAC-CE). In such cases, the configuration may include a set of lists, and each list may include a quantity of Rnn prediction times. For example, an SRS resource configuration may include the following lists: {T₁₁, T₁₂, T₁₃, . . . , T_{1K}}, {T₂₁, T₂₂, T₂₃, . . . , T_{2K}}, and {T_{N1}, T_{N}2, T_{N3}, . . . , T_{NK}}, where N may represent the quantity of lists (e.g., in the set) included in the future time indication and K may represent the quantity of Rnn prediction times included in each list. In some instances, the base station may indicate (e.g., via a DCI 305) which list the UE may use to precode a quantity (e.g., K) of SRSs. In some other cases, the base station may indicate (e.g., via an RRC message or MAC-CE) a parameter (R) which may be associated with a quantity of Rnn prediction times. In some examples, a base station may further indicate (e.g., via a DCI 305) a quantity of Rnn prediction times based on the value of R (e.g., T₁, T₂, . . . , T_{R}). In some cases, R may correspond to a quantity of radio frequency chains included in the UE. In some cases, the UE may then use each Rnn prediction to precode one or more SRSs. Stated alternatively, a UE may use a single Rnn prediction (e.g., an Rnn prediction computed for a single time instance) to precode one or more SRSs. In such cases, the value of K may be greater than the value of R.

In some examples, a base station may transmit control signaling (e.g., via a DCI 305 or RRC message) to configure a UE with one or more interference management resources (e.g., CSI-IM resources 310) for performing interference measurements and one or more SRS resources 315 for precoding Rnn predictions. For example, a base station may transmit, to the UE, a DCI 305 to jointly configure the UE with one or more CSI-IM resources 310 and one or more SRS resources 315. In some cases, the DCI 305 may also include one or more future times which may be associated with each SRS resource 315 and may be used by the UE for Rnn predictions. In some instances, each CSI-IM resource 310 and each SRS resource 315 may be scheduled relative to the DCI 305.

In another example, a base station may transmit an RRC message to a UE to configure the UE with one or more lists of CSI-IM resources 310 and one or more lists of SRS resources 315. In such an example, each list of CSI-IM resources 310 may include a quantity (X) of CSI-IM resources 310 and each list of SRS resources 315 may include a quantity (Y) of SRS resources 315. In some cases, the quantity of indicated SRS resources 315 may correspond a quantity of antennas located at the UE. In some instances, each CSI-IM resource 310 and each SRS resource 315 may include a corresponding configuration (e.g., an antenna configuration at the UE). In some cases, each SRS resource 315 may also be configured with a future time. The future time associated with an SRS resource 315 may be used, by the UE, to predict an Rnn. The predicted Rnn may then be used to precode an SRS which may be transmitted using the associated SRS resource 315. In some other cases, the base station may transmit a future time indication (e.g., via a DCI 305) to indicate future times associated with the configured SRS resources 315. In some examples the future time indication may include a list of future times the UE may use for Rnn predictions. In some cases, the DCI 305 may also indicate a list of CSI-IM resources 310 (e.g., from the one or more configured lists of CSI-IM resources 310) to be used for Rnn measurements and a list of SRS resources 315 (e.g., from the one or more configured lists of SRS resources 315) to be used for precoding the Rnn predictions.

In some examples, the UE may precode the indicate SRS resources 315 in a sequence according to the associate Rnn prediction times (e.g., the future times in which the Rnn prediction is based). For example, as illustrated in FIG. 3, a DCI 305 may indicate a list of (X) CSI-IM resources 310 (e.g., a list including a CSI-IM resource 310-a through a CSI-IM resource 310-x, where x is equal to X), a list of (K) SRS resources 315 (e.g., a list including an SRS resource 315-a through an SRS resource 315-k, where k is equal to K), and a list of (K) future times (e.g., T1, T2, . . . , TK). In such an example, the UE may perform interference measurements using one or more CSI-IM resource 310 to determine Rnn(T0). The UE may then use modeling, based on Rnn(T0), to predict Rnn for each of the indicated Rnn prediction times (e.g., Rnn(T1), Rnn(T2), . . . , Rnn(TK)). Then, in some examples, the UE may precode one or more SRSs with each predicted Rnn and transmit each of the precoded SRSs using the corresponding SRS resources 315. For example, the UE may use the SRS resource 315-a to transmit the one or more SRSs precoded with Rnn(T1) and may use the SRS resource 315-k to transmit the one or more SRS precoded with Rnn(TK). In some cases, the UE may transmit each precoded SRSs simultaneously and, in some other cases, the UE may transmit the SRSs using antenna switching.

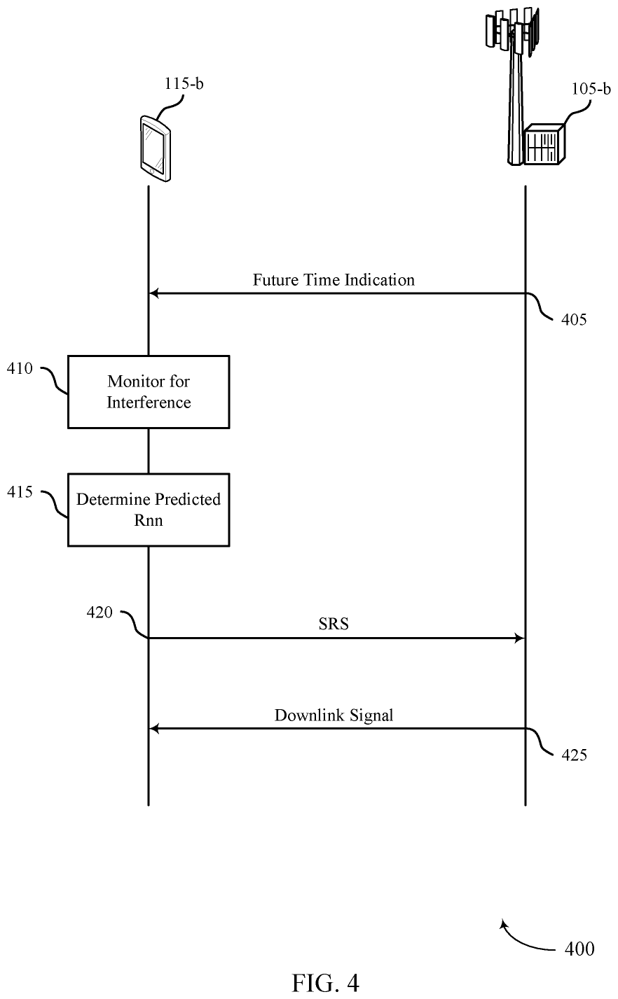

FIG. 4 illustrates an example of a process flow 400 in a system that supports techniques for control signal configuration for reference signal precoding in accordance with aspects of the present disclosure. In some examples, the process flow 400 may implement aspects of the wireless communications systems 100 and 200. For instance, the process flow 400 may illustrate operations between a base station 105-b and a UE 115-b, which may each be examples of the corresponding devices described with reference to FIGS. 1 and 2.

The process flow 400 may be implemented by the base station 105-b, the UE 115-b, or a combination thereof. In the following description of the process flow 400, the information communicated between the base station 105-b and the UE 115-b may be performed in different orders or at different times. Some operations may also be omitted from the process flow 400, and other operations may be added to the process flow 400.

At 405, the base station 105-b may transmit a future time indication to the UE 115-b. In some cases, the future time indication may include one or more future times for which the UE 115-b may be expected to determine a predicted Rnn. In some examples, the base station 105-b may transmit the future time indication in control signaling, such as a DCI message or RRC signaling. In some cases, each future time may be represented as a slot, a subslot, a symbol, a time unit, or a combination thereof

At 410, the UE 115-b may monitor for interference in one or more interference measurement resources (e.g., CSI-IM resources) based on receiving the future time indication. At 415, the UE 115-b may then determine the predicted Rnn based on monitoring for the interference. At 420, the UE 115-b may transmit an SRS to the base station 105-b. In some examples, the SRS may be precoded based on the predicted Rnn.

At 425, the UE 115-b may receive a downlink signal from the base station 105-b at the future time or at a second time. For example, the base station 105-b may use the precoded SRSs to determine CSI parameters (e.g., a PMI, an MCS, or an RI) for transmitting the downlink signal to the UE 115-b. The base station 105-b may use the CSI parameters corresponding to the future time if the downlink signal is scheduled at the future time. Additionally or alternatively, the base station 105-b may use an interpolation to determine the CSI parameters for transmitting the downlink signal at the second time if the second time is between two future times reported by the UE 115-b.

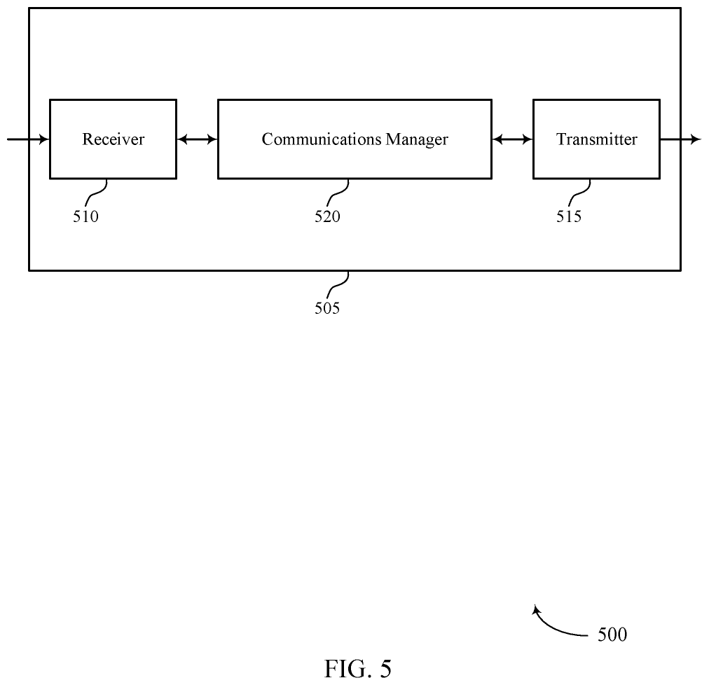

FIG. 5 shows a block diagram 500 of a device 505 that supports techniques for control signal configuration for reference signal precoding in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for control signal configuration for reference signal precoding). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for control signal configuration for reference signal precoding). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for control signal configuration for reference signal precoding as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for receiving, from a base station, an indication of a future time for which the UE is expected to determine a predicted interference covariance matrix. The communications manager 520 may be configured as or otherwise support a means for monitoring for interference in one or more interference measurement resources based on receiving the indication. The communications manager 520 may be configured as or otherwise support a means for determining the predicted interference covariance matrix based on the monitoring for the interference. The communications manager 520 may be configured as or otherwise support a means for transmitting an SRS to the base station, the SRS precoded based on the predicted interference covariance matrix.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, and more efficient utilization of communication resources.

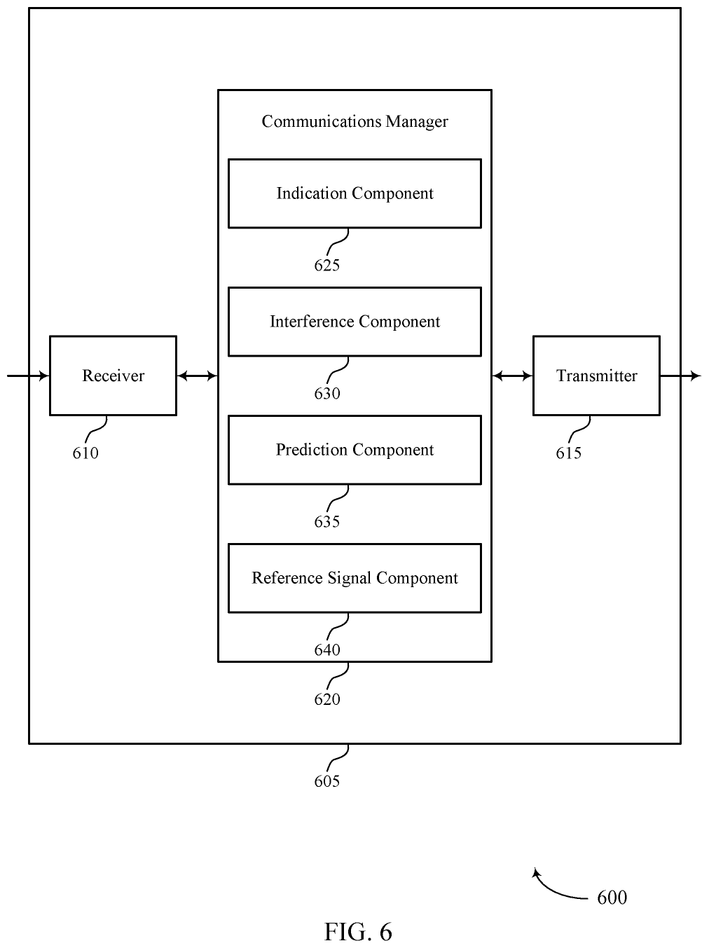

FIG. 6 shows a block diagram 600 of a device 605 that supports techniques for control signal configuration for reference signal precoding in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for control signal configuration for reference signal precoding). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for control signal configuration for reference signal precoding). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for control signal configuration for reference signal precoding as described herein. For example, the communications manager 620 may include an indication component 625, an interference component 630, a prediction component 635, a reference signal component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The indication component 625 may be configured as or otherwise support a means for receiving, from a base station, an indication of a future time for which the UE is expected to determine a predicted interference covariance matrix. The interference component 630 may be configured as or otherwise support a means for monitoring for interference in one or more interference measurement resources based on receiving the indication. The prediction component 635 may be configured as or otherwise support a means for determining the predicted interference covariance matrix based on the monitoring for the interference. The reference signal component 640 may be configured as or otherwise support a means for transmitting an SRS to the base station, the SRS precoded based on the predicted interference covariance matrix.

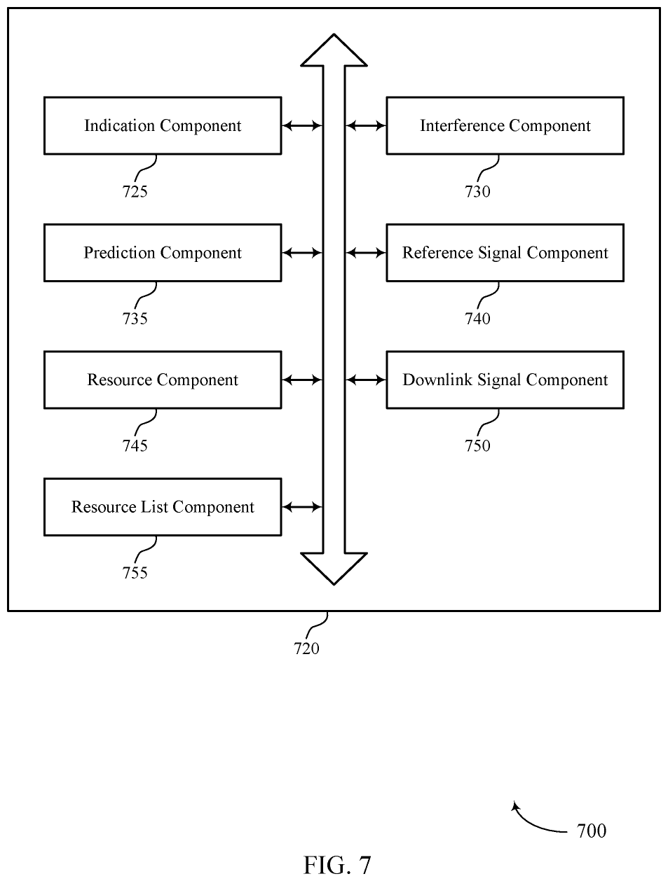

FIG. 7 shows a block diagram 700 of a communications manager 720 that supports techniques for control signal configuration for reference signal precoding in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for control signal configuration for reference signal precoding as described herein. For example, the communications manager 720 may include an indication component 725, an interference component 730, a prediction component 735, a reference signal component 740, a resource component 745, a downlink signal component 750, a resource list component 755, or any combination thereof. Each of these components may communicate, directly or indirectly, with one another (e.g., via one or more buses).

The communications manager 720 may support wireless communications at a UE in accordance with examples as disclosed herein. The indication component 725 may be configured as or otherwise support a means for receiving, from a base station, an indication of a future time for which the UE is expected to determine a predicted interference covariance matrix. The interference component 730 may be configured as or otherwise support a means for monitoring for interference in one or more interference measurement resources based on receiving the indication. The prediction component 735 may be configured as or otherwise support a means for determining the predicted interference covariance matrix based on the monitoring for the interference. The reference signal component 740 may be configured as or otherwise support a means for transmitting an SRS to the base station, the SRS precoded based on the predicted interference covariance matrix.

In some examples, to support receiving the indication, the indication component 725 may be configured as or otherwise support a means for receiving the indication as part of an SRS configuration for transmission of the SRS.

In some examples, to support receiving the indication, the indication component 725 may be configured as or otherwise support a means for receiving first control signaling identifying a set of lists, each list of the set of lists including a respective quantity of future times. In some examples, to support receiving the indication, the indication component 725 may be configured as or otherwise support a means for receiving second control signaling identifying a selected list of the set of lists, the selected list including the indicated future time.

In some examples, the resource list component 755 may be configured as or otherwise support a means for identifying, in the first control signaling, a first resource list including the one or more interference management resources and a second resource list including a set of resources for transmission of the SRS, the set of resources based on an antenna configuration at the UE, where monitoring for the interference and transmitting the SRS are based on identifying the first resource list and the second resource list.

In some examples, to support receiving the indication, the indication component 725 may be configured as or otherwise support a means for receiving first control signaling identifying an integer quantity. In some examples, to support receiving the indication, the indication component 725 may be configured as or otherwise support a means for monitoring, based on receiving the first control signaling, for second control signaling identifying a set of multiple future times whose quantity is the integer quantity. In some examples, to support receiving the indication, the indication component 725 may be configured as or otherwise support a means for receiving the second control signaling based on the monitoring, the set of multiple future times including the indicated future time.

In some examples, the resource component 745 may be configured as or otherwise support a means for receiving control signaling identifying the one or more interference measurement resources and a resource for transmission of the SRS, where monitoring for the interference and transmitting the SRS is based on receiving the control signaling.

In some examples, to support receiving the control signaling, the resource component 745 may be configured as or otherwise support a means for receiving a first identification of a respective time associated with each of the one or more interference measurement resources, each respective time relative to the control signaling. In some examples, to support receiving the control signaling, the resource component 745 may be configured as or otherwise support a means for receiving a second identification of a time associated with the resource for the transmission of the SRS, the time relative to the control signaling.

In some examples, to support determining the predicted interference covariance matrix, the prediction component 735 may be configured as or otherwise support a means for receiving one or more signals based on monitoring for the interference. In some examples, to support determining the predicted interference covariance matrix, the prediction component 735 may be configured as or otherwise support a means for estimating a first interference covariance matrix for a time associated with the one or more interference measurement resources based on receiving the one or more signals. In some examples, to support determining the predicted interference covariance matrix, the prediction component 735 may be configured as or otherwise support a means for determining the predicted interference covariance matrix based on a mean of the one or more signals, an autocorrelation, an auto-covariation, a cross-correlation, a cross-covariance, a stationary interference process, or any combination thereof.

In some examples, the downlink signal component 750 may be configured as or otherwise support a means for receiving, at the future time or at a second time, a downlink signal from the base station based on transmitting the SRS and on the predicted interference covariance matrix.

In some examples, the indication is received in an RRC message, a MAC-CE, a DCI message, or any combination thereof.

In some examples, the future time includes one or more slots, one or more subslots, one or more symbols, or any combination thereof.

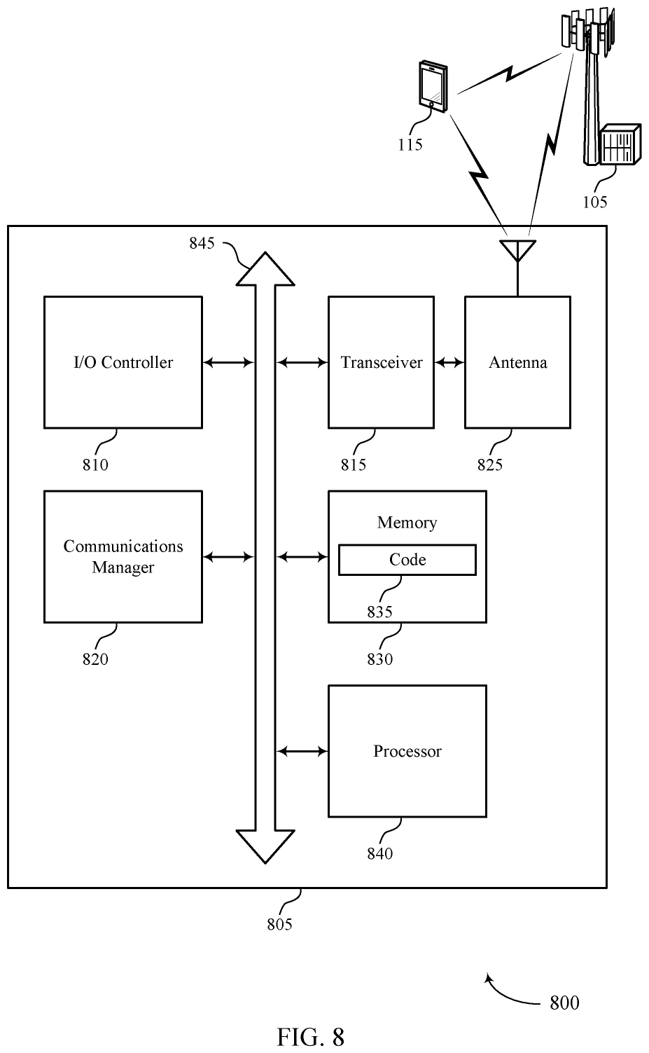

FIG. 8 shows a diagram of a system 800 including a device 805 that supports techniques for control signal configuration for reference signal precoding in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for control signal configuration for reference signal precoding). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, from a base station, an indication of a future time for which the UE is expected to determine a predicted interference covariance matrix. The communications manager 820 may be configured as or otherwise support a means for monitoring for interference in one or more interference measurement resources based on receiving the indication. The communications manager 820 may be configured as or otherwise support a means for determining the predicted interference covariance matrix based on the monitoring for the interference. The communications manager 820 may be configured as or otherwise support a means for transmitting an SRS to the base station, the SRS precoded based on the predicted interference covariance matrix.

By including or configuring the communications manager 820 in accordance with examples as described herein, the device 805 may support techniques for improved communication reliability, reduced latency, more efficient utilization of communication resources, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for control signal configuration for reference signal precoding as described herein, or the processor 840 and the memory 830 may be otherwise configured to perform or support such operations.

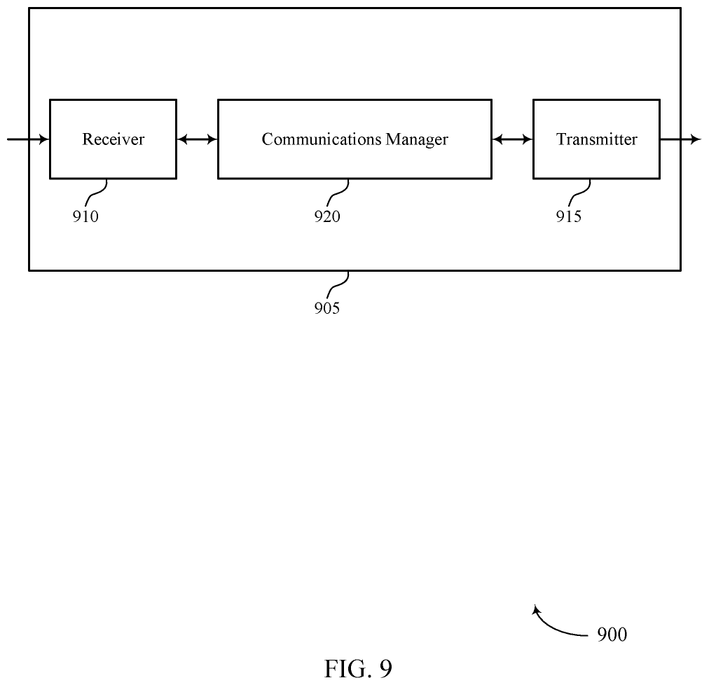

FIG. 9 shows a block diagram 900 of a device 905 that supports techniques for control signal configuration for reference signal precoding in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for control signal configuration for reference signal precoding). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for control signal configuration for reference signal precoding). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for control signal configuration for reference signal precoding as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, an indication of a future time for which the UE is expected to determine a predicted interference covariance matrix. The communications manager 920 may be configured as or otherwise support a means for receiving an SRS from the UE based on transmitting the indication, the SRS precoded based on the predicted interference covariance matrix. The communications manager 920 may be configured as or otherwise support a means for determining the predicted interference covariance matrix based on the SRS. The communications manager 920 may be configured as or otherwise support a means for transmitting a downlink signal using one or more transmission parameters that are based on the predicted interference covariance matrix.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing, reduced power consumption, and more efficient utilization of communication resources.

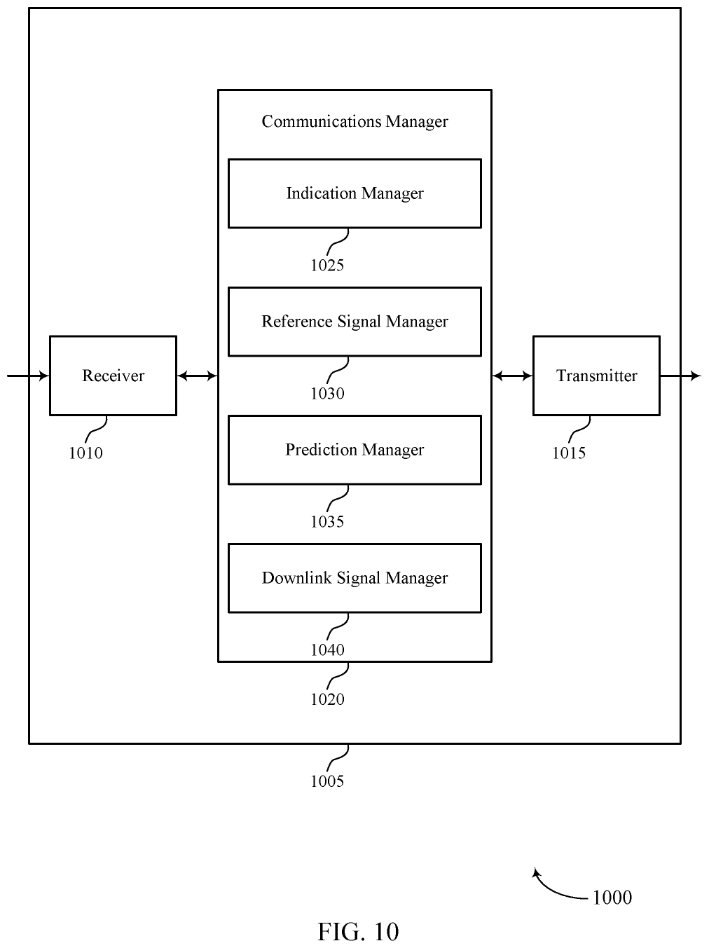

FIG. 10 shows a block diagram 1000 of a device 1005 that supports techniques for control signal configuration for reference signal precoding in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for control signal configuration for reference signal precoding). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for control signal configuration for reference signal precoding). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for control signal configuration for reference signal precoding as described herein. For example, the communications manager 1020 may include an indication manager 1025, a reference signal manager 1030, a prediction manager 1035, a downlink signal manager 1040, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The indication manager 1025 may be configured as or otherwise support a means for transmitting, to a UE, an indication of a future time for which the UE is expected to determine a predicted interference covariance matrix. The reference signal manager 1030 may be configured as or otherwise support a means for receiving an SRS from the UE based on transmitting the indication, the SRS precoded based on the predicted interference covariance matrix. The prediction manager 1035 may be configured as or otherwise support a means for determining the predicted interference covariance matrix based on the SRS. The downlink signal manager 1040 may be configured as or otherwise support a means for transmitting a downlink signal using one or more transmission parameters that are based on the predicted interference covariance matrix.

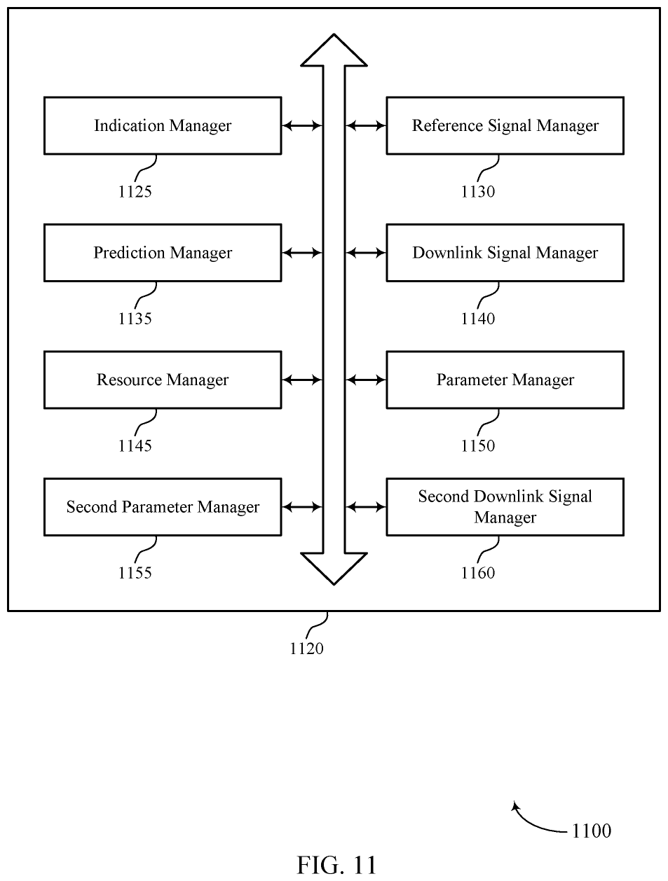

FIG. 11 shows a block diagram 1100 of a communications manager 1120 that supports techniques for control signal configuration for reference signal precoding in accordance with aspects of the present disclosure. The communications manager 1120 may be an example of aspects of a communications manager 920, a communications manager 1020, or both, as described herein. The communications manager 1120, or various components thereof, may be an example of means for performing various aspects of techniques for control signal configuration for reference signal precoding as described herein. For example, the communications manager 1120 may include an indication manager 1125, a reference signal manager 1130, a prediction manager 1135, a downlink signal manager 1140, a resource manager 1145, a parameter manager 1150, a second parameter manager 1155, a second downlink signal manager 1160, or any combination thereof. Each of these components may communicate, directly or indirectly, with one another (e.g., via one or more buses).

The communications manager 1120 may support wireless communications at a base station in accordance with examples as disclosed herein. The indication manager 1125 may be configured as or otherwise support a means for transmitting, to a UE, an indication of a future time for which the UE is expected to determine a predicted interference covariance matrix. The reference signal manager 1130 may be configured as or otherwise support a means for receiving an SRS from the UE based on transmitting the indication, the SRS precoded based on the predicted interference covariance matrix. The prediction manager 1135 may be configured as or otherwise support a means for determining the predicted interference covariance matrix based on the SRS. The downlink signal manager 1140 may be configured as or otherwise support a means for transmitting a downlink signal using one or more transmission parameters that are based on the predicted interference covariance matrix.

In some examples, to support transmitting the indication, the indication manager 1125 may be configured as or otherwise support a means for transmitting the indication as part of an SRS configuration for transmission, by the UE, of the SRS.

In some examples, to support transmitting the indication, the indication manager 1125 may be configured as or otherwise support a means for transmitting first control signaling identifying a set of lists, each list of the set of lists including a respective quantity of future times. In some examples, to support transmitting the indication, the indication manager 1125 may be configured as or otherwise support a means for transmitting second control signaling identifying a selected list of the set of lists, the selected list including the indicated future time.

In some examples, the first control signaling includes a first resource list including the one or more interference management resources and a second resource list including a set of resources for transmission of the SRS, the set of resources based on an antenna configuration at the UE. In some examples, the SRS is received based on the first resource list and the second resource list.

In some examples, to support transmitting the indication, the indication manager 1125 may be configured as or otherwise support a means for transmitting first control signaling identifying an integer quantity. In some examples, to support transmitting the indication, the indication manager 1125 may be configured as or otherwise support a means for transmitting second control signaling identifying a set of multiple future times whose quantity is the integer quantity, the set of multiple future times including the indicated future time.

In some examples, the resource manager 1145 may be configured as or otherwise support a means for transmitting control signaling identifying one or more interference measurement resources and a resource for transmission of the SRS.

In some examples, to support transmitting the control signaling, the resource manager 1145 may be configured as or otherwise support a means for transmitting a first identification of a respective time associated with each of the one or more interference measurement resources, each respective time relative to the control signaling. In some examples, to support transmitting the control signaling, the resource manager 1145 may be configured as or otherwise support a means for transmitting a second identification of a time associated with the resource for the transmission of the SRS, the time relative to the control signaling.

In some examples, the parameter manager 1150 may be configured as or otherwise support a means for determining the one or more transmission parameters for the downlink signal scheduled for transmission at the future time, where the one or more transmission parameters are determined based on the predicted interference covariance matrix.

In some examples, the downlink signal manager 1140 may be configured as or otherwise support a means for transmitting the downlink signal to the UE at the future time based on determining the one or more transmission parameters.

In some examples, the one or more transmission parameters include a precoder, a modulation and coding scheme, a rank indicator, or any combination thereof, associated with the downlink signal.

In some examples, the second parameter manager 1155 may be configured as or otherwise support a means for determining the one or more transmission parameters for the downlink signal scheduled for transmission at a second time, where the one or more transmission parameters are determined based on the predicted interference covariance matrix and an interpolation. In some examples, the second downlink signal manager 1160 may be configured as or otherwise support a means for transmitting the downlink signal to the UE at the second time based on determining the one or more transmission parameters.

In some examples, the indication is transmitted in an RRC message, a MAC-CE a DCI message, or any combination thereof.

In some examples, the future time includes one or more slots, one or more subslots, one or more symbols, or any combination thereof.

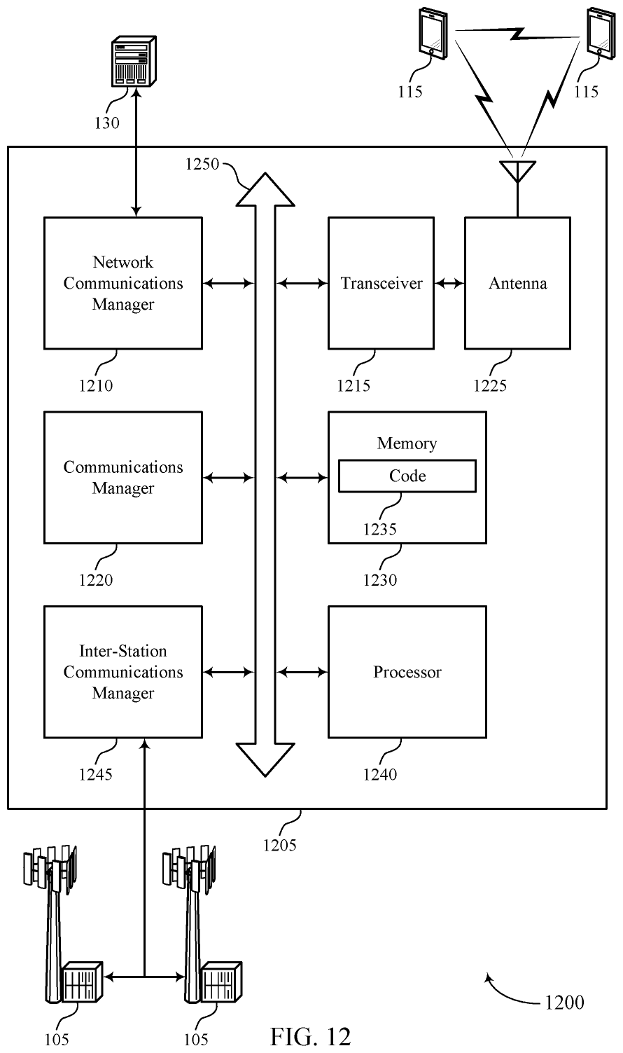

FIG. 12 shows a diagram of a system 1200 including a device 1205 that supports techniques for control signal configuration for reference signal precoding in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for control signal configuration for reference signal precoding). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, an indication of a future time for which the UE is expected to determine a predicted interference covariance matrix. The communications manager 1220 may be configured as or otherwise support a means for receiving an SRS from the UE based on transmitting the indication, the SRS precoded based on the predicted interference covariance matrix. The communications manager 1220 may be configured as or otherwise support a means for determining the predicted interference covariance matrix based on the SRS. The communications manager 1220 may be configured as or otherwise support a means for transmitting a downlink signal using one or more transmission parameters that are based on the predicted interference covariance matrix.

By including or configuring the communications manager 1220 in accordance with examples as described herein, the device 1205 may support techniques for improved communication reliability, reduced latency, reduced power consumption, more efficient utilization of communication resources, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for control signal configuration for reference signal precoding as described herein, or the processor 1240 and the memory 1230 may be otherwise configured to perform or support such operations.

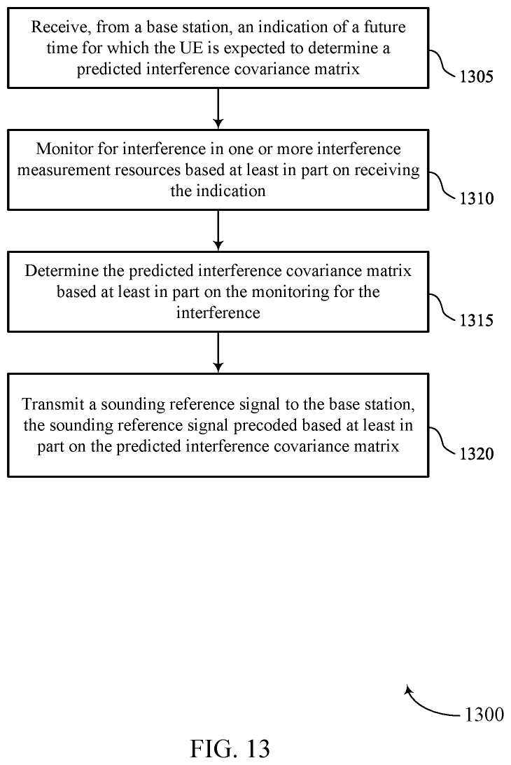

FIG. 13 shows a flowchart illustrating a method 1300 that supports techniques for control signal configuration for reference signal precoding in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, an indication of a future time for which the UE is expected to determine a predicted interference covariance matrix. The operations of 1305 may be performed in accordance with examples as disclosed herein. In some examples, aspects of the operations of 1305 may be performed by an indication component 725 as described with reference to FIG. 7.

At 1310, the method may include monitoring for interference in one or more interference measurement resources based on receiving the indication. The operations of 1310 may be performed in accordance with examples as disclosed herein. In some examples, aspects of the operations of 1310 may be performed by an interference component 730 as described with reference to FIG. 7.

At 1315, the method may include determining the predicted interference covariance matrix based on the monitoring for the interference. The operations of 1315 may be performed in accordance with examples as disclosed herein. In some examples, aspects of the operations of 1315 may be performed by a prediction component 735 as described with reference to FIG. 7.

At 1320, the method may include transmitting an SRS to the base station, the SRS precoded based on the predicted interference covariance matrix. The operations of 1320 may be performed in accordance with examples as disclosed herein. In some examples, aspects of the operations of 1320 may be performed by a reference signal component 740 as described with reference to FIG. 7.

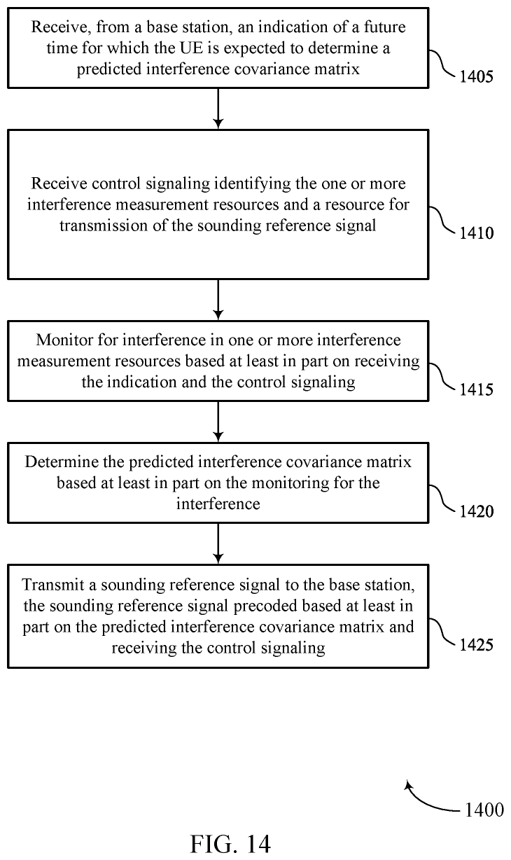

FIG. 14 shows a flowchart illustrating a method 1400 that supports techniques for control signal configuration for reference signal precoding in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, an indication of a future time for which the UE is expected to determine a predicted interference covariance matrix. The operations of 1405 may be performed in accordance with examples as disclosed herein. In some examples, aspects of the operations of 1405 may be performed by an indication component 725 as described with reference to FIG. 7.

At 1410, the method may include receiving control signaling identifying the one or more interference measurement resources and a resource for transmission of the SRS. The operations of 1410 may be performed in accordance with examples as disclosed herein. In some examples, aspects of the operations of 1410 may be performed by a resource component 745 as described with reference to FIG. 7.

At 1415, the method may include monitoring for interference in one or more interference measurement resources based on receiving the indication and the control signaling. The operations of 1415 may be performed in accordance with examples as disclosed herein. In some examples, aspects of the operations of 1415 may be performed by an interference component 730 as described with reference to FIG. 7.

At 1420, the method may include determining the predicted interference covariance matrix based on the monitoring for the interference. The operations of 1420 may be performed in accordance with examples as disclosed herein. In some examples, aspects of the operations of 1420 may be performed by a prediction component 735 as described with reference to FIG. 7.

At 1425, the method may include transmitting an SRS to the base station, the SRS precoded based on the predicted interference covariance matrix and receiving the control signaling. The operations of 1425 may be performed in accordance with examples as disclosed herein. In some examples, aspects of the operations of 1425 may be performed by a reference signal component 740 as described with reference to FIG. 7.

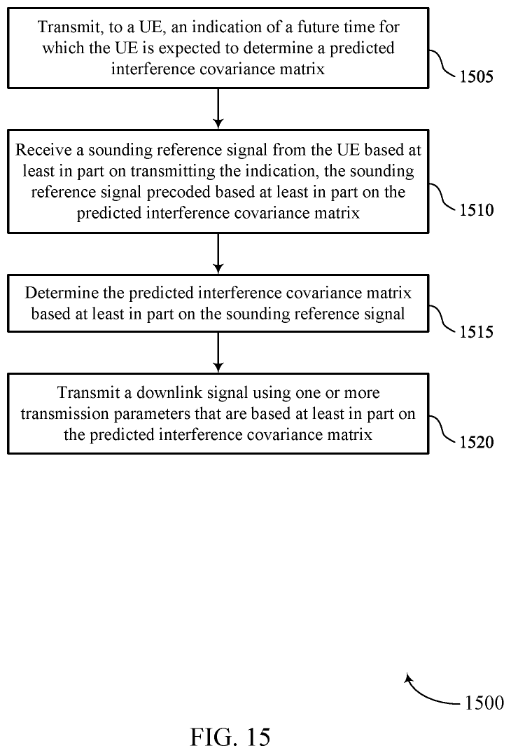

FIG. 15 shows a flowchart illustrating a method 1500 that supports techniques for control signal configuration for reference signal precoding in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, an indication of a future time for which the UE is expected to determine a predicted interference covariance matrix. The operations of 1505 may be performed in accordance with examples as disclosed herein. In some examples, aspects of the operations of 1505 may be performed by an indication manager 1125 as described with reference to FIG. 11.

At 1510, the method may include receiving an SRS from the UE based on transmitting the indication, the SRS precoded based on the predicted interference covariance matrix. The operations of 1510 may be performed in accordance with examples as disclosed herein. In some examples, aspects of the operations of 1510 may be performed by a reference signal manager 1130 as described with reference to FIG. 11.

At 1515, the method may include determining the predicted interference covariance matrix based on the SRS. The operations of 1515 may be performed in accordance with examples as disclosed herein. In some examples, aspects of the operations of 1515 may be performed by a prediction manager 1135 as described with reference to FIG. 11.

At 1520, the method may include transmitting a downlink signal using one or more transmission parameters that are based on the predicted interference covariance matrix. The operations of 1520 may be performed in accordance with examples as disclosed herein. In some examples, aspects of the operations of 1520 may be performed by a downlink signal manager 1140 as described with reference to FIG. 11.

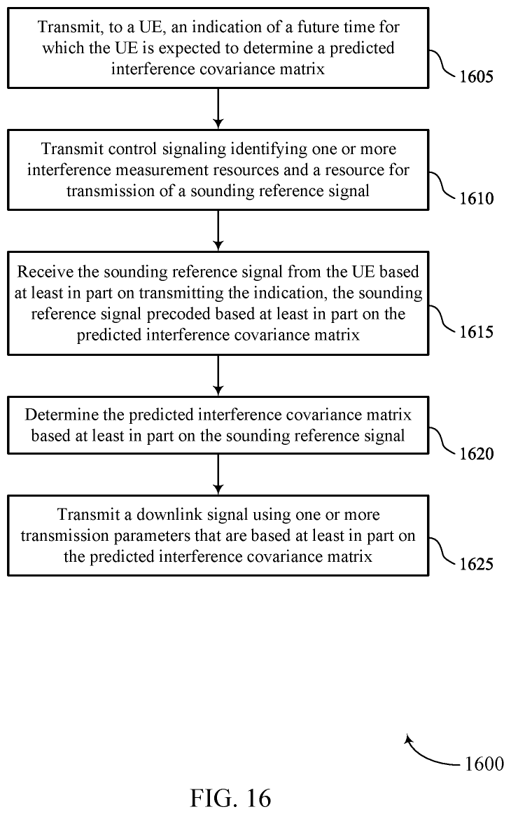

FIG. 16 shows a flowchart illustrating a method 1600 that supports techniques for control signal configuration for reference signal precoding in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, an indication of a future time for which the UE is expected to determine a predicted interference covariance matrix. The operations of 1605 may be performed in accordance with examples as disclosed herein. In some examples, aspects of the operations of 1605 may be performed by an indication manager 1125 as described with reference to FIG. 11.

At 1610, the method may include transmitting control signaling identifying one or more interference measurement resources and a resource for transmission of an SRS. The operations of 1610 may be performed in accordance with examples as disclosed herein. In some examples, aspects of the operations of 1610 may be performed by a resource manager 1145 as described with reference to FIG. 11.

At 1615, the method may include receiving the SRS from the UE based on transmitting the indication, the SRS precoded based on the predicted interference covariance matrix. The operations of 1615 may be performed in accordance with examples as disclosed herein. In some examples, aspects of the operations of 1615 may be performed by a reference signal manager 1130 as described with reference to FIG. 11.

At 1620, the method may include determining the predicted interference covariance matrix based on the SRS. The operations of 1620 may be performed in accordance with examples as disclosed herein. In some examples, aspects of the operations of 1620 may be performed by a prediction manager 1135 as described with reference to FIG. 11.

At 1625, the method may include transmitting a downlink signal using one or more transmission parameters that are based on the predicted interference covariance matrix. The operations of 1625 may be performed in accordance with examples as disclosed herein. In some examples, aspects of the operations of 1625 may be performed by a downlink signal manager 1140 as described with reference to FIG. 11.

The following provides an overview of aspects of the present disclosure:
Aspect 1: A method for wireless communications at a UE, comprising: receiving, from a base station, an indication of a future time for which the UE is expected to determine a predicted interference covariance matrix; monitoring for interference in one or more interference measurement resources based at least in part on receiving the indication; determining the predicted interference covariance matrix based at least in part on the monitoring for the interference; and transmitting a sounding reference signal to the base station, the sounding reference signal precoded based at least in part on the predicted interference covariance matrix.
Aspect 2: The method of aspect 1, wherein receiving the indication comprises: receiving the indication as part of a sounding reference signal configuration for transmission of the sounding reference signal.
Aspect 3: The method of any of aspects 1 through 2, wherein receiving the indication comprises: receiving first control signaling identifying a set of lists, each list of the set of lists comprising a respective quantity of future times; and receiving second control signaling identifying a selected list of the set of lists, the selected list comprising the indicated future time.
Aspect 4: The method of aspect 3, further comprising: identifying, in the first control signaling, a first resource list comprising the one or more interference management resources and a second resource list comprising a set of resources for transmission of the sounding reference signal, the set of resources based at least in part on an antenna configuration at the UE, wherein monitoring for the interference and transmitting the sounding reference signal are based at least in part on identifying the first resource list and the second resource list.
Aspect 5: The method of any of aspects 1 through 4, wherein receiving the indication comprises: receiving first control signaling identifying an integer quantity; monitoring, based at least in part on receiving the first control signaling, for second control signaling identifying a plurality of future times whose quantity is the integer quantity; and receiving the second control signaling based at least in part on the monitoring, the plurality of future times comprising the indicated future time.
Aspect 6: The method of any of aspects 1 through 5, further comprising: receiving control signaling identifying the one or more interference measurement resources and a resource for transmission of the sounding reference signal, wherein monitoring for the interference and transmitting the sounding reference signal is based at least in part on receiving the control signaling.
Aspect 7: The method of aspect 6, wherein receiving the control signaling further comprises: receiving a first identification of a respective time associated with each of the one or more interference measurement resources, each respective time relative to the control signaling; and receiving a second identification of a time associated with the resource for the transmission of the sounding reference signal, the time relative to the control signaling.
Aspect 8: The method of any of aspects 1 through 7, wherein determining the predicted interference covariance matrix comprises: receiving one or more signals based at least in part on monitoring for the interference; estimating a first interference covariance matrix for a time associated with the one or more interference measurement resources based at least in part on receiving the one or more signals; determining the predicted interference covariance matrix based at least in part on a mean of the one or more signals, an autocorrelation, an auto-covariation, a cross-correlation, a cross-covariance, a stationary interference process, or any combination thereof.
Aspect 9: The method of any of aspects 1 through 8, further comprising: receiving, at the future time or at a second time, a downlink signal from the base station based at least in part on transmitting the sounding reference signal and on the predicted interference covariance matrix.
Aspect 10: The method of any of aspects 1 through 9, wherein the indication is received in a radio resource control message, a medium access control control element, a downlink control information message, or any combination thereof.
Aspect 11: The method of any of aspects 1 through 10, wherein the future time comprises one or more slots, one or more subslots, one or more symbols, or any combination thereof.
Aspect 12: A method for wireless communications at a base station, comprising: transmitting, to a UE, an indication of a future time for which the UE is expected to determine a predicted interference covariance matrix; receiving a sounding reference signal from the UE based at least in part on transmitting the indication, the sounding reference signal precoded based at least in part on the predicted interference covariance matrix; determining the predicted interference covariance matrix based at least in part on the sounding reference signal; and transmitting a downlink signal using one or more transmission parameters that are based at least in part on the predicted interference covariance matrix.
Aspect 13: The method of aspect 12, wherein transmitting the indication comprises: transmitting the indication as part of a sounding reference signal configuration for transmission, by the UE, of the sounding reference signal.
Aspect 14: The method of any of aspects 12 through 13, wherein transmitting the indication comprises: transmitting first control signaling identifying a set of lists, each list of the set of lists comprising a respective quantity of future times; and transmitting second control signaling identifying a selected list of the set of lists, the selected list comprising the indicated future time.
Aspect 15: The method of aspect 14, wherein the first control signaling comprises a first resource list comprising the one or more interference management resources and a second resource list comprising a set of resources for transmission of the sounding reference signal, the set of resources based at least in part on an antenna configuration at the UE, and the sounding reference signal is received based at least in part on the first resource list and the second resource list.
Aspect 16: The method of any of aspects 12 through 15, wherein transmitting the indication comprises: transmitting first control signaling identifying an integer quantity; and transmitting second control signaling identifying a plurality of future times whose quantity is the integer quantity, the plurality of future times comprising the indicated future time.
Aspect 17: The method of any of aspects 12 through 16, further comprising: transmitting control signaling identifying one or more interference measurement resources and a resource for transmission of the sounding reference signal.
Aspect 18: The method of aspect 17, wherein transmitting the control signaling further comprises: transmitting a first identification of a respective time associated with each of the one or more interference measurement resources, each respective time relative to the control signaling; and transmitting a second identification of a time associated with the resource for the transmission of the sounding reference signal, the time relative to the control signaling.
Aspect 19: The method of any of aspects 12 through 18, further comprising: determining the one or more transmission parameters for the downlink signal scheduled for transmission at the future time, wherein the one or more transmission parameters are determined based at least in part on the predicted interference covariance matrix.
Aspect 20: The method of aspect 19, further comprising: transmitting the downlink signal to the UE at the future time based at least in part on determining the one or more transmission parameters.
Aspect 21: The method of any of aspects 19 through 20, wherein the one or more transmission parameters comprise a precoder, a modulation and coding scheme, a rank indicator, or any combination thereof, associated with the downlink signal.
Aspect 22: The method of any of aspects 12 through 21, further comprising: determining the one or more transmission parameters for the downlink signal scheduled for transmission at a second time, wherein the one or more transmission parameters are determined based at least in part on the predicted interference covariance matrix and an interpolation; and transmitting the downlink signal to the UE at the second time based at least in part on determining the one or more transmission parameters.
Aspect 23: The method of any of aspects 12 through 22, wherein the indication is transmitted in a radio resource control message, a medium access control control element, a downlink control information message, or any combination thereof.
Aspect 24: The method of any of aspects 12 through 23, wherein the future time comprises one or more slots, one or more subslots, one or more symbols, or any combination thereof.
Aspect 25: A UE, comprising a processor; memory coupled with the processor; and instructions stored in the memory and executable by the processor to cause the apparatus to perform a method of any of aspects 1 through 11.
Aspect 26: A UE, comprising at least one means for performing a method of any of aspects 1 through 11.
Aspect 27: A non-transitory computer-readable medium storing code for wireless communications at a UE, the code comprising instructions executable by a processor to perform a method of any of aspects 1 through 11.
Aspect 28: A base station, comprising a processor; memory coupled with the processor; and instructions stored in the memory and executable by the processor to cause the apparatus to perform a method of any of aspects 12 through 24.
Aspect 29: A base station, comprising at least one means for performing a method of any of aspects 12 through 24.
Aspect 30: A non-transitory computer-readable medium storing code for wireless communications at a base station, the code comprising instructions executable by a processor to perform a method of any of aspects 12 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, an indication of a future time for which the UE is expected to determine a predicted interference covariance matrix;
monitoring for interference in one or more interference measurement resources based at least in part on receiving the indication;
determining the predicted interference covariance matrix based at least in part on the monitoring for the interference; and
transmitting a sounding reference signal to the base station, the sounding reference signal precoded based at least in part on the predicted interference covariance matrix.

2. The method of claim 1, wherein receiving the indication comprises:
receiving the indication as part of a sounding reference signal configuration for transmission of the sounding reference signal.

3. The method of claim 1, wherein receiving the indication comprises:
receiving first control signaling identifying a set of lists, each list of the set of lists comprising a respective quantity of future times; and
receiving second control signaling identifying a selected list of the set of lists, the selected list comprising the indicated future time.

4. The method of claim 3, further comprising:
identifying, in the first control signaling, a first resource list comprising the one or more interference management resources and a second resource list comprising a set of resources for transmission of the sounding reference signal, the set of resources based at least in part on an antenna configuration at the UE, wherein monitoring for the interference and transmitting the sounding reference signal are based at least in part on identifying the first resource list and the second resource list.

5. The method of claim 1, wherein receiving the indication comprises:
receiving first control signaling identifying an integer quantity;
monitoring, based at least in part on receiving the first control signaling, for second control signaling identifying a plurality of future times whose quantity is the integer quantity; and
receiving the second control signaling based at least in part on the monitoring, the plurality of future times comprising the indicated future time.

6. The method of claim 1, further comprising:
receiving control signaling identifying the one or more interference measurement resources and a resource for transmission of the sounding reference signal, wherein monitoring for the interference and transmitting the sounding reference signal is based at least in part on receiving the control signaling.

7. The method of claim 6, wherein receiving the control signaling further comprises:
receiving a first identification of a respective time associated with each of the one or more interference measurement resources, each respective time relative to the control signaling; and
receiving a second identification of a time associated with the resource for the transmission of the sounding reference signal, the time relative to the control signaling.

8. The method of claim 1, wherein determining the predicted interference covariance matrix comprises:
receiving one or more signals based at least in part on monitoring for the interference;
estimating a first interference covariance matrix for a time associated with the one or more interference measurement resources based at least in part on receiving the one or more signals;
determining the predicted interference covariance matrix based at least in part on a mean of the one or more signals, an autocorrelation, an auto-covariation, a cross-correlation, a cross-covariance, a stationary interference process, or any combination thereof.

9. The method of claim 1, further comprising:
receiving, at the future time or at a second time, a downlink signal from the base station based at least in part on transmitting the sounding reference signal and on the predicted interference covariance matrix.

10. The method of claim 1, wherein the indication is received in a radio resource control message, a medium access control control element, a downlink control information message, or any combination thereof.

11. The method of claim 1, wherein the future time comprises one or more slots, one or more subslots, one or more symbols, or any combination thereof.

12. A method for wireless communications at a base station, comprising:
transmitting, to a user equipment (UE), an indication of a future time for which the UE is expected to determine a predicted interference covariance matrix;
receiving a sounding reference signal from the UE based at least in part on transmitting the indication, the sounding reference signal precoded based at least in part on the predicted interference covariance matrix;
determining the predicted interference covariance matrix based at least in part on the sounding reference signal; and
transmitting a downlink signal using one or more transmission parameters that are based at least in part on the predicted interference covariance matrix.

13. The method of claim 12, wherein transmitting the indication comprises:
transmitting the indication as part of a sounding reference signal configuration for transmission, by the UE, of the sounding reference signal.

14. The method of claim 12, wherein transmitting the indication comprises:
transmitting first control signaling identifying a set of lists, each list of the set of lists comprising a respective quantity of future times; and
transmitting second control signaling identifying a selected list of the set of lists, the selected list comprising the indicated future time.

15. The method of claim 14, wherein
the first control signaling comprises a first resource list comprising the one or more interference management resources and a second resource list comprising a set of resources for transmission of the sounding reference signal, the set of resources based at least in part on an antenna configuration at the UE, and
the sounding reference signal is received based at least in part on the first resource list and the second resource list.

16. The method of claim 12, wherein transmitting the indication comprises:
transmitting first control signaling identifying an integer quantity; and
transmitting second control signaling identifying a plurality of future times whose quantity is the integer quantity, the plurality of future times comprising the indicated future time.

17. The method of claim 12, further comprising:
transmitting control signaling identifying one or more interference measurement resources and a resource for transmission of the sounding reference signal.

18. The method of claim 17, wherein transmitting the control signaling further comprises:
transmitting a first identification of a respective time associated with each of the one or more interference measurement resources, each respective time relative to the control signaling; and
transmitting a second identification of a time associated with the resource for the transmission of the sounding reference signal, the time relative to the control signaling.

19. The method of claim 12, further comprising:
determining the one or more transmission parameters for the downlink signal scheduled for transmission at the future time, wherein the one or more transmission parameters are determined based at least in part on the predicted interference covariance matrix.

20. The method of claim 19, further comprising:
transmitting the downlink signal to the UE at the future time based at least in part on determining the one or more transmission parameters.

21. The method of claim 19, wherein the one or more transmission parameters comprise a precoder, a modulation and coding scheme, a rank indicator, or any combination thereof, associated with the downlink signal.

22. The method of claim 12, further comprising:
determining the one or more transmission parameters for the downlink signal scheduled for transmission at a second time, wherein the one or more transmission parameters are determined based at least in part on the predicted interference covariance matrix and an interpolation; and
transmitting the downlink signal to the UE at the second time based at least in part on determining the one or more transmission parameters.

23. The method of claim 12, wherein the indication is transmitted in a radio resource control message, a medium access control control element, a downlink control information message, or any combination thereof.

24. The method of claim 12, wherein the future time comprises one or more slots, one or more subslots, one or more symbols, or any combination thereof.

25. A user equipment (UE), comprising:
a processor;
memory coupled with the processor; and
instructions stored in the memory and executable by the processor to cause the UE to:
receive, from a base station, an indication of a future time for which the UE is expected to determine a predicted interference covariance matrix;
monitor for interference in one or more interference measurement resources based at least in part on receiving the indication;
determine the predicted interference covariance matrix based at least in part on the monitoring for the interference; and
transmit a sounding reference signal to the base station, the sounding reference signal precoded based at least in part on the predicted interference covariance matrix.

26. The UE of claim 25, wherein the instructions to receive the indication are executable by the processor to cause the UE to:
receive the indication as part of a sounding reference signal configuration for transmission of the sounding reference signal.

27. The UE of claim 25, wherein the instructions to receive the indication are executable by the processor to cause the UE to:
receive first control signaling identifying a set of lists, each list of the set of lists comprising a respective quantity of future times; and
receive second control signaling identifying a selected list of the set of lists, the selected list comprising the indicated future time.

28. A base station, comprising:
a processor;
memory coupled with the processor; and
instructions stored in the memory and executable by the processor to cause the base station to:
transmit, to a user equipment (UE), an indication of a future time for which the UE is expected to determine a predicted interference covariance matrix;
receive a sounding reference signal from the UE based at least in part on transmitting the indication, the sounding reference signal precoded based at least in part on the predicted interference covariance matrix;
determine the predicted interference covariance matrix based at least in part on the sounding reference signal; and
transmit a downlink signal using one or more transmission parameters that are based at least in part on the predicted interference covariance matrix.

29. The base station of claim 28, wherein the instructions to transmit the indication are executable by the processor to cause the base station to:
transmit the indication as part of a sounding reference signal configuration for transmission, by the UE, of the sounding reference signal.

30. The base station of claim 28, wherein the instructions to transmit the indication are executable by the processor to cause the base station to:
transmit first control signaling identifying a set of lists, each list of the set of lists comprising a respective quantity of future times; and
transmit second control signaling identifying a selected list of the set of lists, the selected list comprising the indicated future time.
